(19) United States
(12) Patent Application Publication
(10) Pub. No.: US 2010/0004122 A1
(43) Pub. Date: Jan. 7, 2010

(54) Exhaust Gas-Purifying Catalyst

(75) Inventors: Asuka HORI, Kakegawa-shi (JP); Akimasa Hirai, Kakegawa-shi (JP); Keiichi Narita, Kakegawa-shi (JP)

Correspondence Address: MORRISON & FOERSTER, LLP, 555 WEST FIFTH STREET, SUITE 3500, LOS ANGELES, CA, 90013-1024, US

(73) Assignee: CATALER CORPORATION, Kakegawa-shi (JP)

(21) Appl. No.: 12/560,550

(22) Filed: Sep. 16, 2009

Related U.S. Application Data
(63) Continuation of application No. PCT/JP2008/055504, filed on Mar. 25, 2008.

(30) Foreign Application Priority Data
Apr. 5, 2007 (JP) 2007/099548

(51) Int. Cl. B01J 23/10

(52) U.S. Cl. 502/303; 502/304

(57) ABSTRACT

A high NOₓ-purifying performance at high temperature conditions is achieved with a small amount of precious metal used. An exhaust gas-purifying catalyst includes a substrate, a lower layer formed on the substrate and including a first composite oxide, palladium and platinum, and an upper layer formed on the lower layer and including a second composite oxide and rhodium. The first composite oxide includes cerium, zirconium, and an element selected from the group consisting of rare-earth elements other than cerium and alkaline-earth elements. A mass ratio of platinum with respect to palladium falls within a range of 1/50 to 1/20. The second composite oxide includes zirconium and an element selected from the group consisting of rare-earth elements other than cerium and alkaline-earth elements and has an atomic ratio of cerium with respect to zirconium smaller than that of the first composite oxide.

### CROSS-REFERENCE TO RELATED APPLICATIONS

This is a Continuation Application of PCT Application No. PCT/JP2008/055504, filed Mar. 25, 2008, which was published under PCT Article 21(2) in Japanese.

This application is based upon and claims the benefit of priority from prior Japanese Patent Application No. 2007-099548, filed Apr. 5, 2007, the entire contents of which are incorporated herein by reference.

### BACKGROUND OF THE INVENTION

1. Field of the Invention

The present invention relates to an exhaust gas-purifying catalyst.

2. Description of the Related Art

Jpn. Pat. Appln. KOKAI Publication No. 7-60117 discloses an exhaust gas-purifying catalyst produced by forming on a substrate first and second wash-coated layers in this order. The first and second wash-coated layers contain alumina. The first wash-coated layer further contains cerium, zirconium and palladium. The second wash-coated layer does not contain palladium and zirconium but further contains platinum, rhodium, barium and cerium. The palladium content of the first wash-coated layer falls within a range of 0.2 to 2.0 g/L. The platinum content and rhodium content of the second wash-coated layer fall within a range of 0.1 to 2.0 g/L and a range of 0.05 to 0.65 g/L, respectively.

When no platinum is used, increasing the rhodium content can achieve a sufficiently high NOₓ-purifying performance at high temperature conditions. When rhodium is used in large quantity, however, superiority in cost will be reduced.

### BRIEF SUMMARY OF THE INVENTION

An object of the present invention is to achieve a high NOₓ-purifying performance at high temperature conditions with a small amount of precious metal used.

According to an aspect of the present invention, there is provided an exhaust gas-purifying catalyst comprising a substrate, a lower layer formed on the substrate and including a first composite oxide, palladium and platinum, the first composite oxide including cerium, zirconium, and an element selected from the group consisting of rare-earth elements other than cerium and alkaline-earth elements, and a mass ratio of platinum with respect to palladium falling within a range of 1/50 to 1/20, and an upper layer formed on the lower layer and including a second composite oxide and rhodium, the second composite oxide including zirconium and an element selected from the group consisting of rare-earth elements other than cerium and alkaline-earth elements and having an atomic ratio of cerium with respect to zirconium smaller than that of the first composite oxide.

### BRIEF DESCRIPTION OF THE SEVERAL VIEWS OF THE DRAWING

FIG. 1 is a perspective view schematically showing an exhaust gas-purifying catalyst according to an embodiment of the present invention;

FIG. 2 is a sectional view schematically showing an example of structures that can be employed in the exhaust gas-purifying catalyst shown in FIG. 1; and

FIG. 3 is a graph showing an NOₓ-purifying performance.

### DETAILED DESCRIPTION OF THE INVENTION

Embodiments of the present invention will be described below.

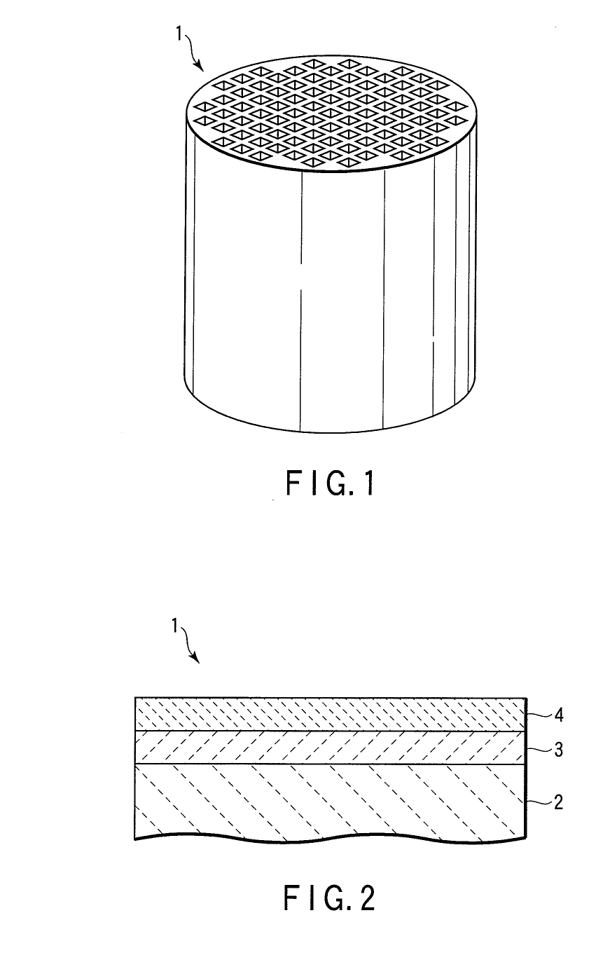

FIG. 1 is a perspective view schematically showing an exhaust gas-purifying catalyst according to an embodiment of the present invention. FIG. 2 is a sectional view schematically showing an example of structures that can be employed in the exhaust gas-purifying catalyst shown in FIG. 1.

The exhaust gas-purifying catalyst 1 shown in FIGS. 1 and 2 is a monolith catalyst. The exhaust gas-purifying catalyst 1 includes a substrate 2 such as a monolith honeycomb substrate. Typically, the substrate 2 is made of ceramics such as cordierite.

On the wall of the substrate 2, a lower layer 3 is formed. The lower layer 3 includes a first composite oxide, palladium and platinum.

The first composite oxide includes cerium, zirconium, and an element selected from the group consisting of rare-earth elements other than cerium and alkaline-earth elements. The first composite oxide may be a composite oxide having a single composition or a mixture including a plurality of composite oxides.

As the rare-earth element of the first composite oxide other than cerium, one or more of praseodymium, lanthanum, yttrium and neodymium can be used, for example.

As the alkaline-earth element of the first composite oxide, one or more of barium, strontium, calcium and magnesium can be used, for example.

As the first composite oxide, a composite oxide including cerium, zirconium, lanthanum and yttrium; a composite oxide including cerium, zirconium, lanthanum and barium; a composite oxide including cerium, zirconium, neodymium and yttrium; a composite oxide including cerium, zirconium, lanthanum, neodymium and praseodymium; or a composite oxide including cerium, zirconium, neodymium, praseodymium and calcium can be used, for example.

The sum of equivalent oxide contents for cerium and zirconium in the first composite oxide, that is, the sum of ceria and zirconia contents is set, for example, within a range of 5 to 30% by mass. In the case where this value is small or great, it is possible that a sufficient performance is not achieved.

In the first composite oxide, the mass ratio of ceria with respect to zirconia is set, for example, within a range of 80/100 to 100/70, typically within a range of 80/100 to 100/90, and more typically 80/100 to 90/100. In the case where this value is small, it is possible that the oxygen storage capacity of the first oxide is insufficient. When a large amount of an oxygen storage material is used in order to compensate for this, it is possible that the heat capacity increases to reduce the activity at low temperatures. In the case where this value is great, it is possible that the oxygen storage capacity is not developed efficiently and thus an exhaust gas is not sufficiently purified due to the reduced oxygen storage capacity.

The precious metal content of the lower layer 3 is set, for example, within a range of 0.5 to 3.0% by mass. In the case where this value is small, achieving a sufficient exhaust gas-purifying capacity is difficult. When this value is increased, the cost will increase and the sintering thereof will become prone to occur.

In the lower layer 3, the mass ratio of platinum with respect to palladium is set, for example, within a range of 1/50 to 1/20, and typically within a range of 1/50 to 1/30. When this value is decreased, achieving a high NOₓ-purifying performance in high temperature conditions becomes difficult. When this value is increased, the superiority in cost will be reduced.

The lower layer 3 may further include a first refractory carrier having a heat stability superior to that of the first composite oxide. As the material of the first refractory carrier, alumina, zirconia, titania, ceria or silica can be used, for example.

The coating amount of the lower layer 3 per 1 L of volumetric capacity of the substrate 2 is set, for example, within a range of 20 to 200 g. In the case where the coating amount is small, achieving a sufficient exhaust gas-purifying capacity is difficult. In the case where the coating amount is large, the heat capacity of the exhaust gas-purifying catalyst 1 increases.

On the lower layer 3, an upper layer 4 is formed. The upper layer 4 includes a second composite oxide and rhodium.

The second composite oxide further includes zirconium and an element selected from the group consisting of rare-earth elements other than cerium and alkaline-earth elements. The second composite oxide may be a composite oxide having a single composition or a mixture including a plurality of composite oxides.

As the rare-earth element of the second composite oxide other than cerium, one or more of praseodymium, lanthanum, yttrium and neodymium can be used, for example. The second composite oxide may further include cerium.

As the alkaline-earth element of the second composite oxide, one or more of barium, strontium, calcium and magnesium can be used, for example.

As the second composite oxide, a composite oxide including cerium, zirconium, lanthanum and neodymium; a composite oxide including cerium, zirconium, yttrium and strontium; a composite oxide including cerium, zirconium, lanthanum and praseodymium; a composite oxide including cerium, zirconium, lanthanum and yttrium; or their corresponding composite oxides from which cerium is omitted can be used, for example.

The sum of equivalent oxide contents for cerium and zirconium in the second composite oxide is set, for example, within a range of 5 to 30% by mass. In the case where this value is small or great, it is possible that a sufficient performance is not achieved.

The second composite oxide has an atomic ratio of cerium with respect to zirconium smaller than that of the first composite oxide. This increases the NOₓ-purifying performance in high temperature conditions as compared with the case where the ratio for the first composite oxide and the ratio for the second composite oxide are set equal to each other or the case where the ratio for the first composite oxide is set smaller than the ratio for the second composite oxide.

In the second composite oxide, the mass ratio of ceria with respect to zirconia is set at, for example, 30/100 or less, typically 20/100 or less, and more typically 10/100 or less. In the case where this value is great, it is possible that the oxygen storage capacity hinders reactions and purification and thus the catalytic performance is reduced.

The rhodium content of the upper layer 4 is set, for example, within a range of 0.1 to 2.0% by mass. In the case where this value is small, achieving a sufficient exhaust gas-purifying capacity is difficult. When this value is increased, the cost will increase and the sintering thereof will become prone to occur.

The upper layer 4 may further includes a second refractory carrier having a heat stability superior to that of the second composite oxide. As the material of the second refractory carrier, alumina, zirconia, titania, ceria or silica can be used, for example.

The coating amount of the lower upper 4 per 1 L of volumetric capacity of the substrate 2 is set, for example, within a range of 20 to 200 g. In the case where the coating amount is small, achieving a sufficient exhaust gas-purifying capacity is difficult. In the case where the coating amount is increased, the heat capacity of the exhaust gas-purifying catalyst 1 will increase.

The exhaust gas-purifying catalyst 1 may further include a layer other than the lower layer 3 and the upper layer 4, for example, a layer including an oxygen storage material such as ceria. This additional layer may be placed between the substrate 2 and the lower layer 3, between the lower layer 3 and the upper layer 4, or above the upper layer 4.

Examples of the present invention will be described below.

<Preparation of Catalyst C1>

In this example, the exhaust gas-purifying catalyst 1 shown in FIG. 2 was prepared by the following method.

First, aqueous platinum nitrate containing 0.064 g of platinum, aqueous palladium nitrate containing 1.94 g of palladium, 50 g of alumina powder, 100 g of composite oxide powder A1, 20 g of barium sulfate, 200 g of deionized water were mixed together to prepare slurry. As the composite oxide powder A1, used was the one containing cerium, zirconium, and a rare-earth element other than cerium at equivalent oxide contents of 40, 50 and 10 parts by mass, respectively. Lanthanum and yttrium were used as the rare-earth element other than cerium. Hereinafter, the slurry is referred to as “slurry S1”.

Subsequently, a monolith honeycomb substrate 2 was coated with the whole amount of the slurry S1. Here, used was a monolith honeycomb substrate having a volumetric capacity of 1.0 L and made of cordierite. The monolith honeycomb substrate 2 was dried at 250° C. for 1 hour. A lower layer 3 before firing was thus formed on the monolith honeycomb substrate 2.

Next, aqueous rhodium nitrate containing 0.5 g of rhodium, 50 g of alumina powder, 50 g of composite oxide powder B1, and 200 g of deionized water were mixed together to prepare slurry. As the composite oxide powder B1, used was the one containing cerium, zirconium, and a rare-earth element other than cerium at equivalent oxide contents of 20.8, 69.2 and 10 parts by mass, respectively. Lanthanum and neodymium were used as the rare-earth element other than cerium. Hereinafter, the slurry is referred to as “slurry S2”.

Subsequently, the above monolith honeycomb substrate 2 was coated with the whole amount of the slurry S2. The monolith honeycomb substrate 2 was dried at 250° C. for 1 hour. An upper layer 4 before firing was thus formed on the unfired lower layer 3.

Thereafter, the monolith honeycomb substrate 2 was fired at 500° C. for 1 hour. The exhaust gas-purifying catalyst 1 shown in FIG. 2 was thus completed. Hereinafter, the exhaust gas-purifying catalyst 1 is referred to as “catalyst C1”.

<Preparation of Catalyst C2>

Aqueous rhodium nitrate containing 0.5 g of rhodium, 50 g of alumina powder, 50 g of composite oxide powder B2, and 200 g of deionized water were mixed together to prepare slurry. As the composite oxide powder B2, used was the one containing cerium, zirconium, and a rare-earth element other than cerium at equivalent oxide contents of 5.1, 84.9 and 10 parts by mass, respectively. Lanthanum and neodymium were used as the rare-earth element other than cerium. Hereinafter, the slurry is referred to as “slurry S3”.

In this example, the exhaust gas-purifying catalyst 1 shown in FIG. 2 was prepared by the same method as that described for the catalyst C1 except that the slurry S3 was used instead of the slurry S2. Hereinafter, the exhaust gas-purifying catalyst 1 is referred to as “catalyst C2”.

<Preparation of Catalyst C3>

Aqueous rhodium nitrate containing 0.5 g of rhodium, 50 g of alumina powder, 50 g of composite oxide powder B3, and 200 g of deionized water were mixed together to prepare slurry. As the composite oxide powder B3, used was the one containing zirconium and a rare-earth element other than cerium at equivalent oxide contents of 90 and 10 parts by mass, respectively. Lanthanum and neodymium were used as the rare-earth element other than cerium. Hereinafter, the slurry is referred to as “slurry S4”.

In this example, the exhaust gas-purifying catalyst 1 shown in FIG. 2 was prepared by the same method as that described for the catalyst C1 except that the slurry S4 was used instead of the slurry S2. Hereinafter, the exhaust gas-purifying catalyst 1 is referred to as “catalyst C3”.

<Preparation of Catalyst C4>

Aqueous platinum nitrate containing 0.064 g of platinum, aqueous palladium nitrate containing 1.94 g of palladium, 50 g of alumina powder, 100 g of composite oxide powder A2, 20 g of barium sulfate, and 200 g of deionized water were mixed together to prepare slurry. As the composite oxide powder A2, used was the one containing cerium, zirconium and a rare-earth element other than cerium at equivalent oxide contents of 52.9, 37.1 and 10 parts by mass, respectively. Lanthanum and yttrium were used as the rare-earth element other than cerium. Hereinafter, the slurry is referred to as “slurry S5”.

In this example, the exhaust gas-purifying catalyst 1 shown in FIG. 2 was prepared by the same method as that described for the catalyst C1 except that the slurry S5 was used instead of the slurry S1 and the slurry S3 was used instead of the slurry S2. Hereinafter, the exhaust gas-purifying catalyst 1 is referred to as “catalyst C4”.

<Preparation of Catalyst C5>

Aqueous platinum nitrate containing 0.064 g of platinum, aqueous palladium nitrate containing 1.94 g of palladium, 50 g of alumina powder, 100 g of composite oxide powder A3, 20 g of barium sulfate, and 200 g of deionized water were mixed together to prepare slurry. As the composite oxide powder A3, used was the one containing cerium, zirconium and a mixture of a rare-earth element other than cerium and an alkaline-earth element at equivalent oxide contents of 40, 50 and 10 parts by mass, respectively. Praseodymium was used as the rare-earth element other than cerium, while barium was used as the alkaline-earth element. Hereinafter, the slurry is referred to as “slurry S6”.

In this example, the exhaust gas-purifying catalyst 1 shown in FIG. 2 was prepared by the same method as that described for the catalyst C1 except that the slurry S6 was used instead of the slurry S1 and the slurry S3 was used instead of the slurry S2. Hereinafter, the exhaust gas-purifying catalyst 1 is referred to as “catalyst C5”.

<Preparation of Catalyst C6>

Aqueous rhodium nitrate containing 0.5 g of rhodium, 50 g of alumina powder, 50 g of composite oxide powder B4, and 200 g of deionized water were mixed together to prepare slurry. As the composite oxide powder B4, used was the one containing cerium, zirconium and a rare-earth element other than cerium at equivalent oxide contents of 5.1, 84.9 and 10 parts by mass, respectively. Neodymium and yttrium were used as the rare-earth element other than cerium. Hereinafter, the slurry is referred to as “slurry S7”.

In this example, the exhaust gas-purifying catalyst 1 shown in FIG. 2 was prepared by the same method as that described for the catalyst C1 except that the slurry S7 was used instead of the slurry S2. Hereinafter, the exhaust gas-purifying catalyst 1 is referred to as “catalyst C6”.

<Preparation of Catalyst C7>

Aqueous platinum nitrate containing 0.095 g of platinum, aqueous palladium nitrate containing 1.9 g of palladium, 50 g of alumina powder, 100 g of the composite oxide powder A1, 20 g of barium sulfate, and 200 g of deionized water were mixed together to prepare slurry. Hereinafter, the slurry is referred to as “slurry S8”.

In this example, the exhaust gas-purifying catalyst 1 shown in FIG. 2 was prepared by the same method as that described for the catalyst C1 except that the slurry S8 was used instead of the slurry S1 and the slurry S3 was used instead of the slurry S2. Hereinafter, the exhaust gas-purifying catalyst 1 is referred to as “catalyst C7”.

<Preparation of Catalyst C8>

Aqueous platinum nitrate containing 0.049 g of platinum, aqueous palladium nitrate containing 1.95 g of palladium, 50 g of alumina powder, 100 g of the composite oxide powder A1, 20 g of barium sulfate, and 200 g of deionized water were mixed together to prepare slurry. Hereinafter, the slurry is referred to as “slurry S9”.

In this example, the exhaust gas-purifying catalyst 1 shown in FIG. 2 was prepared by the same method as that described for the catalyst C1 except that the slurry S9 was used instead of the slurry S1 and the slurry S3 was used instead of the slurry S2. Hereinafter, the exhaust gas-purifying catalyst 1 is referred to as “catalyst C8”.

<Preparation of Catalyst C9>

Aqueous platinum nitrate containing 0.039 g of platinum, aqueous palladium nitrate containing 1.96 g of palladium, 50 g of alumina powder, 100 g of the composite oxide powder A1, 20 g of barium sulfate, and 200 g of deionized water were mixed together to prepare slurry. Hereinafter, the slurry is referred to as “slurry S10”.

In this example, the exhaust gas-purifying catalyst 1 shown in FIG. 2 was prepared by the same method as that described for the catalyst C1 except that the slurry S10 was used instead of the slurry S1 and the slurry S3 was used instead of the slurry S2. Hereinafter, the exhaust gas-purifying catalyst 1 is referred to as “catalyst C9”.

<Preparation of Catalyst C10>

Aqueous platinum nitrate containing 0.064 g of platinum, aqueous palladium nitrate containing 1.94 g of palladium, 50 g of alumina powder, 100 g of composite oxide powder A4, 20 g of barium sulfate, 200 g of deionized water were mixed together to prepare slurry. As the composite oxide powder A4, used was the one containing cerium, zirconium, and a rare-earth element other than cerium at equivalent oxide contents of 5.1, 84.9 and 10 parts by mass, respectively. Lanthanum and yttrium were used as the rare-earth element other than cerium. Hereinafter, the slurry is referred to as “slurry S11”.

Then, aqueous rhodium nitrate containing 0.5 g of rhodium, 50 g of alumina powder, 50 g of composite oxide powder B5, and 200 g of deionized water were mixed together to prepare slurry. As the composite oxide powder B5, used was the one containing cerium, zirconium, and a rare-earth element other than cerium at equivalent oxide contents of 52.9, 37.1 and 10 parts by mass, respectively. Lanthanum and neodymium were used as the rare-earth element other than cerium. Hereinafter, the slurry is referred to as “slurry S12”.

In this example, the exhaust gas-purifying catalyst 1 shown in FIG. 2 was prepared by the same method as that described for the catalyst C1 except that the slurry S11 was used instead of the slurry S1 and the slurry S12 was used instead of the slurry S2. Hereinafter, the exhaust gas-purifying catalyst 1 is referred to as “catalyst C10”.

<Preparation of Catalyst C11>

Aqueous platinum nitrate containing 0.064 g of platinum, aqueous palladium nitrate containing 1.94 g of palladium, 50 g of alumina powder, 100 g of composite oxide powder A5, 20 g of barium sulfate, 200 g of deionized water were mixed together to prepare slurry. As the composite oxide powder A5, used was the one containing cerium and zirconium at equivalent oxide contents of 44.4 and 55.6 parts by mass, respectively. Hereinafter, the slurry is referred to as “slurry S13”.

In this example, the exhaust gas-purifying catalyst 1 shown in FIG. 2 was prepared by the same method as that described for the catalyst C1 except that the slurry S13 was used instead of the slurry S1 and the slurry S3 was used instead of the slurry S2. Hereinafter, the exhaust gas-purifying catalyst 1 is referred to as “catalyst C11”.

<Preparation of Catalyst C12>

Aqueous rhodium nitrate containing 0.5 g of rhodium, 50 g of alumina powder, 50 g of composite oxide powder B6, and 200 g of deionized water were mixed together to prepare slurry. As the composite oxide powder B6, used was the one containing cerium and zirconium at equivalent oxide contents of 5.7 and 94.3 parts by mass, respectively. Hereinafter, the slurry is referred to as “slurry S14”.

In this example, the exhaust gas-purifying catalyst 1 shown in FIG. 2 was prepared by the same method as that described for the catalyst C1 except that the slurry S14 was used instead of the slurry S2. Hereinafter, the exhaust gas-purifying catalyst 1 is referred to as “catalyst C12”.

<Preparation of Catalyst C13>

Aqueous platinum nitrate containing 0.064 g of platinum, aqueous palladium nitrate containing 1.94 g of palladium, 50 g of alumina powder, 100 g of composite oxide powder A6, 20 g of barium sulfate, 200 g of deionized water were mixed together to prepare slurry. As the composite oxide powder A6, used was the one containing cerium and a rare-earth element other than cerium at equivalent oxide contents of 90 and 10 parts by mass, respectively. Lanthanum and yttrium were used as the rare-earth element other than cerium. Hereinafter, the slurry is referred to as “slurry S15”.

In this example, the exhaust gas-purifying catalyst 1 shown in FIG. 2 was prepared by the same method as that described for the catalyst C1 except that the slurry S15 was used instead of the slurry S1 and the slurry S3 was used instead of the slurry S2. Hereinafter, the exhaust gas-purifying catalyst 1 is referred to as “catalyst C13”.

<Preparation of Catalyst C14>

Aqueous platinum nitrate containing 0.033 g of platinum, aqueous palladium nitrate containing 1.97 g of palladium, 50 g of alumina powder, 100 g of the composite oxide powder A1, 20 g of barium sulfate, 200 g of deionized water were mixed together to prepare slurry. Hereinafter, the slurry is referred to as “slurry S16”.

In this example, the exhaust gas-purifying catalyst 1 shown in FIG. 2 was prepared by the same method as that described for the catalyst C1 except that the slurry S16 was used instead of the slurry S1 and the slurry S3 was used instead of the slurry S2. Hereinafter, the exhaust gas-purifying catalyst 1 is referred to as “catalyst C14”.

<Preparation of Catalyst C15>

Aqueous palladium nitrate containing 2.00 g of palladium, 50 g of alumina powder, 100 g of the composite oxide powder A1, 20 g of barium sulfate, 200 g of deionized water were mixed together to prepare slurry. Hereinafter, the slurry is referred to as “slurry S17”.

In this example, the exhaust gas-purifying catalyst 1 shown in FIG. 2 was prepared by the same method as that described for the catalyst C1 except that the slurry S17 was used instead of the slurry S1 and the slurry S3 was used instead of the slurry S2. Hereinafter, the exhaust gas-purifying catalyst 1 is referred to as “catalyst C15”.

Constituents of the lower layer 3 and the upper layer 4 of the catalysts C1 to C15 are summarized in the following Tables 1 and 2. In Tables 1 and 2, the column denoted by “CeO₂/ZrO₂” shows mass ratios of ceria with respect to zirconia. The column denoted by “RE, AE” shows the rare-earth elements and alkaline-earth elements used. The column denoted by “Pt/Pd” shows mass ratios of platinum with respect to palladium. The column denoted by “Precious metal amount (g)” shows total amounts of the precious metals contained in the lower layer 3 and the upper layer 4.

TABLE 1

| | | | | | | Precious |
|---|---|---|---|---|---|---|
| | Lower layer | | | | | metal |
| | CeO₂/ | | | Upper layer | | amount |
| Catalyst | ZrO₂ | RE, AE | Pt/Pd | CeO₂/ZrO₂ | RE, AE | (g) |
| C1 | 80/100 | La, Y | 1/30 | 30/100 | La, Nd | 2.504 |
| C2 | 80/100 | La, Y | 1/30 | 6/100 | La, Nd | 2.504 |
| C3 | 80/100 | La, Y | 1/30 | 0/100 | La, Nd | 2.504 |
| C4 | 100/70 | La, Y | 1/30 | 6/100 | La, Nd | 2.504 |
| C5 | 80/100 | Pr, Ba | 1/30 | 6/100 | La, Nd | 2.504 |
| C6 | 80/100 | La, Y | 1/30 | 6/100 | Nd, Y | 2.504 |
| C7 | 80/100 | La, Y | 1/20 | 6/100 | La, Nd | 2.495 |
| C8 | 80/100 | La, Y | 1/40 | 6/100 | La, Nd | 2.499 |
| C9 | 80/100 | La, Y | 1/50 | 6/100 | La, Nd | 2.499 |

TABLE 2

| | | | | | | Precious |
|---|---|---|---|---|---|---|
| | Lower layer | | | | | metal |
| | CeO₂/ | | | Upper layer | | amount |
| Catalyst | ZrO₂ | RE, AE | Pt/Pd | CeO₂/ZrO₂ | RE, AE | (g) |
| C10 | 6/100 | La, Y | 1/30 | 100/70 | La, Nd | 2.504 |
| C11 | 80/100 | — | 1/30 | 6/100 | La, Nd | 2.504 |
| C12 | 80/100 | La, Y | 1/30 | 6/100 | — | 2.504 |
| C13 | 100/0 | La, Y | 1/30 | 6/100 | La, Nd | 2.504 |
| C14 | 80/100 | La, Y | 1/60 | 6/100 | La, Nd | 2.503 |
| C15 | 80/100 | La, Y | 0 | 6/100 | La, Nd | 2.500 |

<Tests>

Each of the catalysts C1 to C15 was mounted in an exhaust system for a gasoline engine having a piston displacement of 4,000 cc. Then, the engine was driven for 50 hours while an average engine speed was maintained at 3,500 rpm and the gas temperature at the inlet of the catalyst was kept at 800° C.

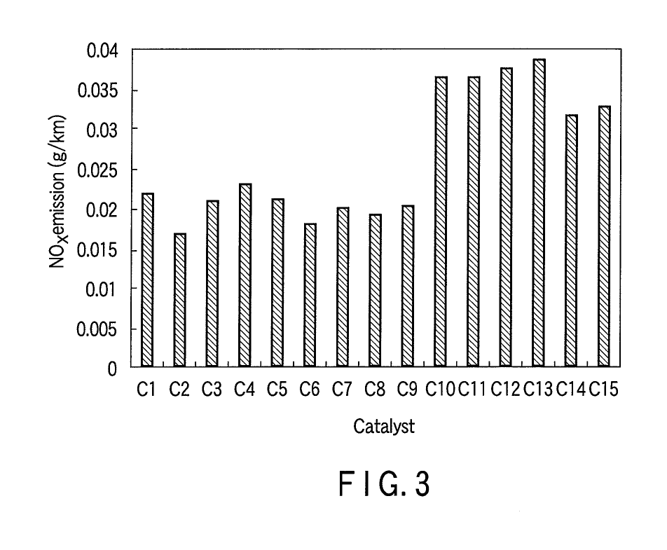

Next, each of the catalysts C1 to C15 was mounted on an automobile having an engine with a piston displacement of 1,500 cc. Then, an emission per 1 km of travel distance was determined for NOₓ emitted from the tailpipe by 10 and 15-mode method. FIG. 3 shows the results.

FIG. 3 is a graph showing an NOₓ-purifying performance. As will be apparent from the graph and Tables 1 and 2, although the catalysts C1 to C9 have a low platinum content and a low total precious metal content, they achieved a higher NOₓ-purifying performance at high temperature conditions as compared with the catalysts C10 to C15.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An exhaust gas-purifying catalyst comprising:
a substrate;
a lower layer formed on the substrate and including a first composite oxide, palladium and platinum, the first composite oxide including cerium, zirconium, and an element selected from the group consisting of rare-earth elements other than cerium and alkaline-earth elements, and a mass ratio of platinum with respect to palladium falling within a range of 1/50 to 1/20; and
an upper layer formed on the lower layer and including a second composite oxide and rhodium, the second composite oxide including zirconium and an element selected from the group consisting of rare-earth elements other than cerium and alkaline-earth elements and having an atomic ratio of cerium with respect to zirconium smaller than that of the first composite oxide.

2. The exhaust gas-purifying catalyst according to claim 1, wherein the first composite oxide includes at least one element selected from the group consisting of lanthanum, yttrium, neodymium and praseodymium.

3. The exhaust gas-purifying catalyst according to claim 2, wherein the second composite oxide includes at least one element selected from the group consisting of lanthanum, yttrium, neodymium and praseodymium.

4. The exhaust gas-purifying catalyst according to claim 3, wherein the first composite oxide has an equivalent oxide ratio of cerium with respect to zirconium falling within a range of 80/100 to 100/70, and the second composite oxide has an equivalent oxide ratio of cerium with respect to zirconium falling within a range of 0/100 to 30/100.

5. The exhaust gas-purifying catalyst according to claim 1, wherein the second composite oxide includes at least one element selected from the group consisting of lanthanum, yttrium, neodymium and praseodymium.

6. The exhaust gas-purifying catalyst according to claim 1, wherein the first composite oxide has an equivalent oxide ratio of cerium with respect to zirconium falling within a range of 80/100 to 100/70, and the second composite oxide has an equivalent oxide ratio of cerium with respect to zirconium falling within a range of 0/100 to 30/100.
